(19) United States
(12) Patent Application Publication
(10) Pub. No.: US 2001/0029500 A1
(43) Pub. Date: Oct. 11, 2001

(54) Image storage, printed matter production system, and method

(75) Inventor: Masahide Tanaka, Kawasaki-shi (JP)

Correspondence Address: OLIFF & BERRIDGE, PLC, 277 S. WASHINGTON STREET, SUITE 500, ALEXANDRIA, VA, 22314, US

(73) Assignee: NIKON CORPORATION AND NIKON TECHNOLOGIES INC

(21) Appl. No.: 09/816,227

(22) Filed: Mar. 26, 2001

(30) Foreign Application Priority Data
Mar. 28, 2000 (JP) 2000-88338

(51) Int. Cl. G06F 17/30

(52) U.S. Cl. 707/3; 707/200

(57) ABSTRACT

An image storage has a memory for digital image data of providers, a condition for each provider in storing the digital image being controlled in accordance with the history of use by image users. The image storage searches the memory for digital image data fulfilling a given condition set on the history of use. A type of printer suitable for individual production or another type of printer suitable for mass production is selected in accordance with the number of orders for producing prints. Printed matter such as a calendar is produced by a method comprising a step of proposing optional digital image data for selection by potential image users, accepting the selections by the potential image users, and deciding on a mass production of printed matter in accordance with the selections. The printed matter can also be produced in accordance with an individual selection of image user. The image user is informed of the total result of the selections of all the other image users to have a chance of changing its initial selection. A printed matter producing system has a container including a plurality of groups of sub-containers each keeping a plurality of sheets of print produced on one image source, respectively. The system also has a selector for selecting one sheet from a sub-container of every group, respectively, the option of the sub-container among every group being depending on an order by an image user. The selected sheets are bound into printed matter.

### BACKGROUND OF THE INVENTION

This application is based upon and claims priority of Japanese Patent Applications No. 2000-88338 filed on Mar. 28, 2000, the contents being incorporated herein by reference.

1. Field of the Invention

The invention relates to a data storage and a printed matter production on the basis of the data in the data storage, and more particularly to a digital image storage and a calendar production system.

2. Description of Related Art

In this field of the art, various types of image storage and systems for facilitating the circulation of image products have been proposed.

In the circulation of such image products, the relationship among image providers as image creators, image product company and image users is to be considered. If an image provider does not agree to provide its image creation to an image product company or an image product company is not satisfied with the image creation of the image provider, any image product never comes into the market even in a case that image users would be satisfied with such an image product. If image users are not satisfied with an image product actually on the market on the other hand, the image provider and the image product company fail in their business. These risks always accompany a mass production business.

There have been proposed various improvements in the field of product circulation in general, such as in U.S. Pat. No. 6,101,484, and Japanese Laid-Open Patent Applications No.7-123351, No.7-319898, No.8-72328, No.9-114996, No.10-108005, No.10-108006, No.10-150553, No.10-214295, No.10-232854, No.10-269049, No.11-102035, No.11-192758, No.11-192762, and No.11-220719.

However, there have been problems and disadvantages still left in the related arts. For example, the related arts have not satisfactorily fulfilled the demand by both the image providers and the image users on the convenience and cost of the product circulation.

### SUMMARY OF THE INVENTION

In order to overcome the problems and disadvantages, the invention provides an image storage having a memory for storing a plurality of digital image data provided by a plurality of image providers. The image storage further has a recorder for recording the history of use by a plurality of image users with respect to each of the digital image data and a controller for controlling a condition for each image provider in storing the digital image in accordance with the recorder. Specifically, the condition for each image provider is the number of the digital image data that the image provider is entitled to store in the memory. The controller controls the condition in accordance with the number of orders in a predetermined period for the digital image data of the image provider. In other words, the controller increases the number of the digital image data for the image provider if the number of the order for the digital image data of the image provider increases.

The increase in the number of the digital image data for the image provider means a better chance for the image provider of getting orders since the selection of image users within the same image provider are widened by the increased number of its image data.

The above feature of the invention serves as a method of facilitating the circulation of digital image data stored in a memory.

On the other hand, the recorder of the invention is utilized for facilitating a search of the digital image data. In other words, the invention provides a searcher for searching the memory for digital image data fulfilling a given condition set on the history recorded by the recorder. The given condition may be set on the number of orders from the image users for each of the digital image data recorded by the recorder. This makes it possible for an image user to search a digital image data depending on the popularity of the digital image data.

Alternatively, the given condition may be set on the image provider with the condition in storing the digital image. This makes it possible for an image user to search a digital image data depending on the popularity of the image provider who stores the image.

The recorder of the invention is also utilized for economical production of the print on the digital image data. In other words, the invention provides a selector that selects one of a plurality of types of printers for producing a print of a digital image data in accordance with an order from an image user. Specifically, the selector selects the printer between a first type of printer suitable for individual production of the print of a digital image data and a second type of printer suitable for mass production of the print of the digital image data in accordance with the number of orders for producing prints of the digital image data from the image users.

The invention also provides a method of producing printed matter such as a calendar from a plurality of digital image data stored in a memory comprising the steps of proposing a plurality of optional digital image data for selection by a plurality of potential image users for printed matter, accepting the selections by the potential image users, and deciding on a mass production of printed matter in accordance with the accepted selections. Due to the steps, a mass production is possible with a less risk.

The invention further provides a method of producing printed matter comprising the steps of proposing a plurality of groups of optional digital image data for selection by a plurality of image users for printed matter, accepting the selections of one digital image data from every group by each image user, and producing printed matter for each image user in accordance with the selections, respectively. By these steps, the invention provides printed matter according to the individual order by an image use with less cost.

The invention still further provides a method of producing printed matter characterized by a step of informing each image user of the total result of the selections by all the other image users for allowing each image user to change the initial selection in view of the informed total result. This is advantageous for both an image user and printed matter producer to seek a low cost printed matter production.

The invention also provides printed matter producing system comprising a container including a plurality of groups of sub-containers each keeping a plurality of sheets of print produced on one image source, respectively. The system further comprises a selector for selecting one sheet from a sub-container of every group, respectively, the option of the sub-container among every group being depending on an order by an image user for printed matter. The selected sheets are bound into printed matter.

The feature of the invention is applicable not only to storage of digital image data or the production of printed matter therefrom, but also to storage of other digital data or to a production of other products.

Other features and advantages according to the invention will be readily understood from the detailed description of the preferred embodiment in conjunction with the accompanying drawings.

### BRIEF DESCRIPTION OF THE DRAWINGS

FIG. 1 represents a computer network system of an embodiment according to the invention.

FIG. 2 represents a block diagram of image storage of the embodiment in detail.

FIG. 3 represents a flow chart showing the main flow to be carried out by the embodiment.

FIG. 4 represents a flow chart showing the process of storing or deleting the image data in image storage.

FIG. 5 represents a flow chart showing the process of utilizing the image data in image storage.

FIG. 6 represents a flow chart showing the details of the process in step S25 in FIG. 5.

FIG. 7 represents a flow chart showing the details of the search process in step S19 of FIG. 5.

FIG. 8 represents a flowchart showing a calendar ordering process in step S26 of FIG. 5 in detail.

FIG. 9 represents a flowchart showing a calendar producing process.

FIG. 10 represents a block diagram showing a calendar production apparatus.

### DETAILED DESCRIPTION OF THE PREFERRED EMBODIMENT

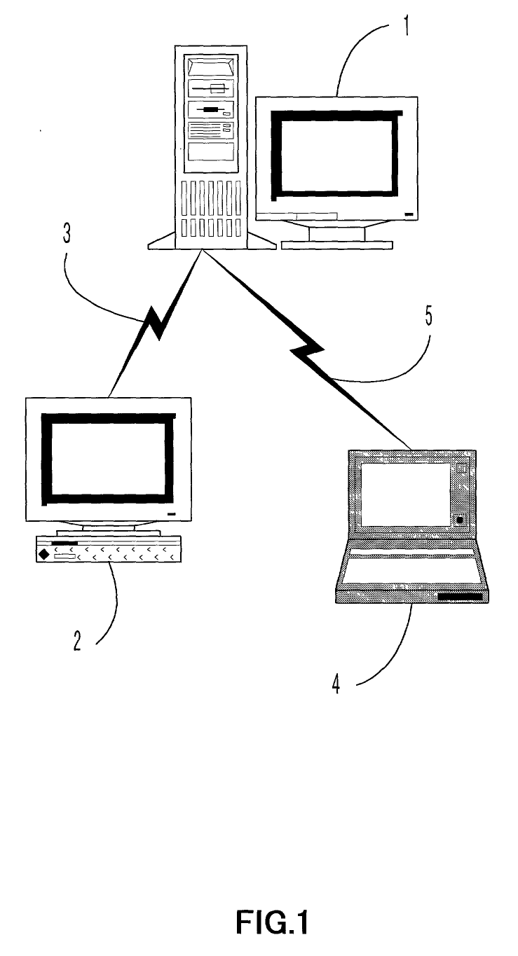

FIG. 1 represents a computer network system of an embodiment according to the invention. In FIG. 1, image storage 1 is in communication with personal computer 2 of an image provider, who personally creates images to be stored in image storage 1, through a network system 3 such as a wireless communication system or the Internet. Image storage 1 is also in communication with personal computer 4 of an image user, who is to purchase or use the image stored in image storage 1, through a similar network system 5. Though FIG. 1 is simplified in which only one image provider and only one image user are referred to for example, any of unlimited image providers or image users can freely access image storage 1 if the similar communication therewith is desired.

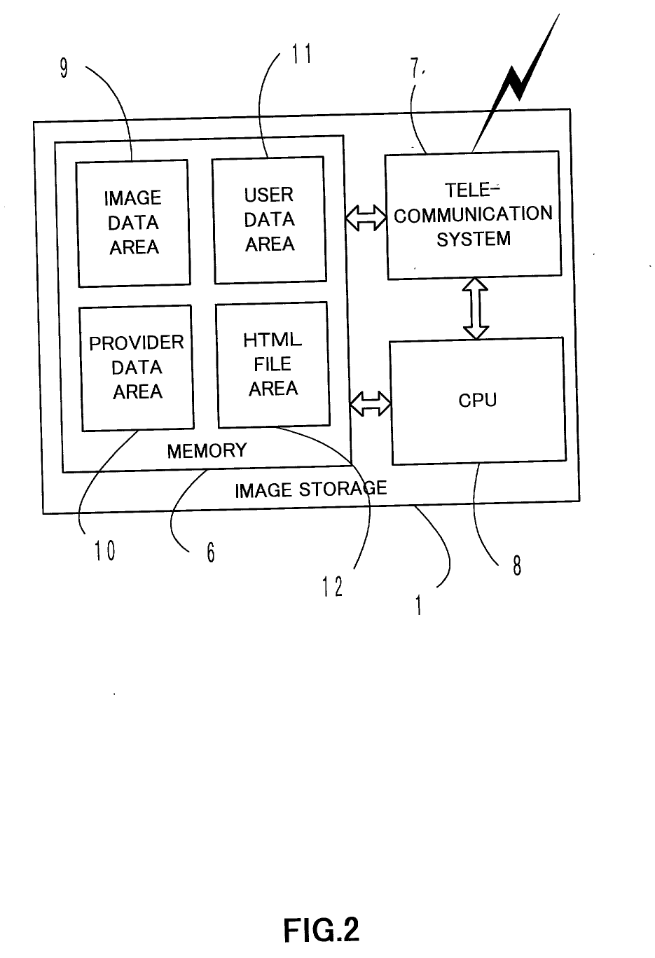

FIG. 2 represents a block diagram of image storage 1 in detail. In FIG. 2, memory 6, telecommunication system 7, and CPU(Central Processor Unit) 8 are connected in the network for data communication. Memory 6 includes image data area 9 for storing image data transmitted from the personal computer of image provider 2, provider data area 10 for recording the relationship between the image data and the image provider, user data area 11 for recording the relationship between the image data and the image user, and HTML(Hyper Text Markup Language) file area 12 for storing image data to be transmitted to personal computer 2 or 4 for the monitor thereon by the image provider or the image user. For the purpose of explanation, the areas are shown in the separated blocks in FIG. 2, respectively. However, memory 6 in practice is not concretely divided into such blocks, but the areas are only of functional concepts. As mentioned with respect to FIG. 1, telecommunication system 7 is in communication with personal computer 2 of the image provider or personal computer 4 of the image user.

Provider data area 10 keeps various data including a grade of each provider with a limitation to the number of image data that each image provider is entitled to store in storage 1, date of providing each image data, and date and number of orders from image users for each image data, such data being stored with relation to each image data in image data area 9. Image data in image data area 9 are to be classified according to various criteria such as the image provider by name, the image provider by grade, the image data by the number of orders. Provider data area 10 further keeps general data not relating to the individuality of the image provider such as the field to which the image data generally belongs, the general data being also stored with relation to each image data in image data area 9. Image data in image data area 9 are also to be classified according to the general data.

User data area 11 keeps various data including access date to each image data by each image user, order date for each image data by each image user, and data of order contents, such data being stored with relation to each image data in image data area 9. Image data in image data area 9 are to be classified according to such data in user data area 11.

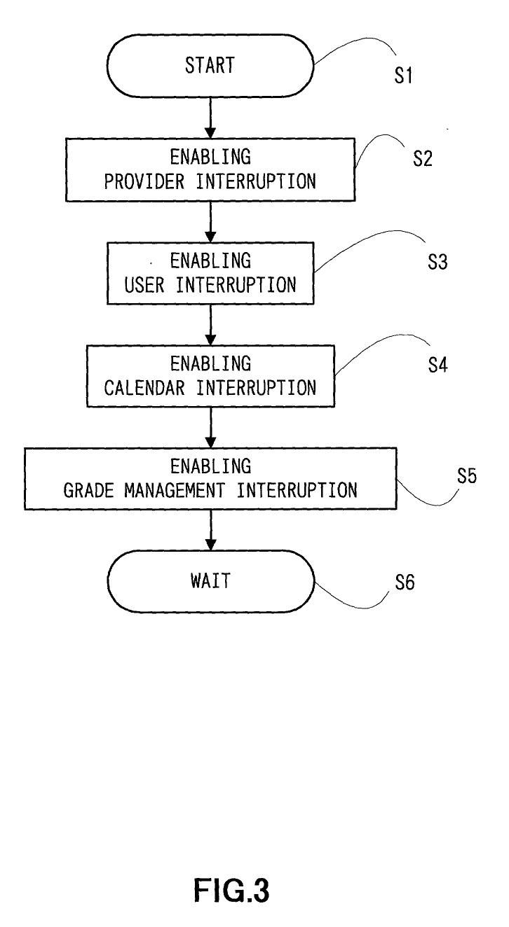

FIG. 3 represents a flow chart showing the main flow to be carried out by CPU 8 of image storage 1. The flow beginning with step S1 enables various interruptions in steps S2 to S5 to cause a waiting state in step S6. Provider interruption enabled in step S2 is to be caused when an image provider accesses image storage 1 for providing an image. User interruption enabled in step S3 is to be caused when an image user accesses image storage 1 for a desired image data. Calendar interruption enabled in step S4 is to be caused when a calendar is to be produced in response to an order from an image user. Grade management interruption enabled in step S5 is to be automatically caused once a day. The purpose of the grade management interruption is to reduce the number of image data that an image provider is entitled to store in storage 1 if no order is made for a long time for the image data of the image provider.

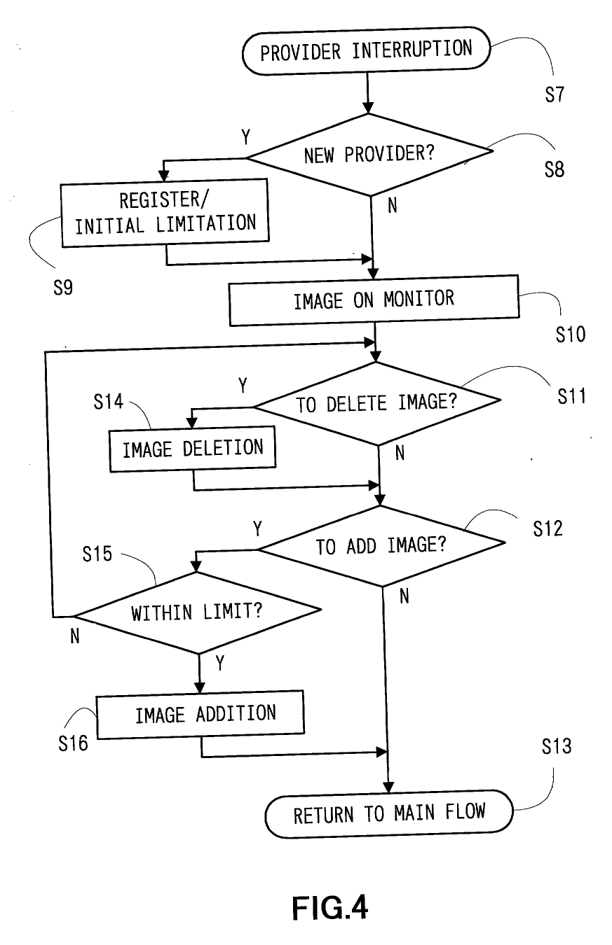

FIG. 4 represents a flow chart showing the process of storing or deleting the image data in image storage 1 beginning with an access form an image provider, which causes the provider interruption in step S7. Further in step S7, the accessing image provider is identified with name, e-mail address, and telephone number, for example. If the image provider is of already registered, the identification number and the password are utilized in identifying the accessing image provider in step S7. The purpose of the identification of the accessing image provider is to limit the number of image data to be provided by the same image provider under a predetermined rule of grade, which is to be explained later.

If the identified image provider is a new one in step S8, the flow goes to step S9, in which the new image provider is registered with an identification number and a password and given an initial limitation to the number of image data that the new image provider is entitled to store. According to the embodiment, the initial limitation is “one”. In other words, any new image provider is entitled to provide and store one image data free of charge upon the registration. If the identified image provider is not a new image provider in step S8, the flow directly goes to step S10 contrary to the case of the new image provider by way of step S9.

In step S10, all data for the identified image provider are gotten from image data area 9 and provider data area 10, and transmitted to personal computer 2 of the identified image provider for the monitor thereon by the aid of the function of HTML file area 12. In the case of a new image provider, of course, no image data is transmitted. The accessing image provider is to add or delete image data through the personal computer 2. If no data is requested to be deleted in step S11, nor any data is requested to be added in step S12, the flow goes back to the main flow in step S13. This means that the intention of the accessing image provider is to only confirm the own image data stored in image storage 1.

On the contrary, if an image data is requested to be deleted in step S11, the flow goes to step S14, in which an image deletion procedure is carried out. In the case that an image data is requested to be added in step S12, the flow goes to step S15 for checking whether or not the resultant number of the image data remains within the limit. If the resultant number is within the limit, an image addition procedure is carried out in step S16 followed by step S13. On the other hand, if the resultant number is to exceed the limit, the flow cannot go to step S16, but returns to step S11. This means that an addition of new image data is refused unless an old image data is to be deleted from image storage 1 to make room for a new one. If the image provider desires to substitute a new image data for an old one, the old image data stored in image storage 1 is deleted through steps S11 and S14, and the new image data can be added through steps S12, S15 and S16.

The rule of grading image providers is summarized as follows:

1. Charge on storing image data: Free.

2. Term of storing image data: Three months for each image data, the term restarting on a substitution of a new image data for the old one, which is repeatable.

3. Limitation for a new image provider: One image data

4. Limitation for an image provider who keeps getting an order from one image user per one month: Two image data.

5. Limitation for an image provider who keeps getting orders from two or more image users per one month: Five image data.

6. Limitation for an image provider who keeps getting orders from one hundred or more image users per one month: Twenty image data.

7. Limitation for an image provider who keeps getting orders from one thousand or more image users per one month: One hundred image data.

As is understood from the above rule, the embodiment of the invention records the history of the orders from the image users for image data of each image provider, and determines the condition for each image provider of storing the image data in accordance with the achievement by each image provider of getting orders. In other words, the more an image provider has gotten orders in a month, the more the image provider is entitled to store image data in next month. Thus, the grade of each image provider is upgraded or downgraded depending on the achievement of the image provider. The achievement is estimated by recording the number of orders for each image data within a predetermined period.

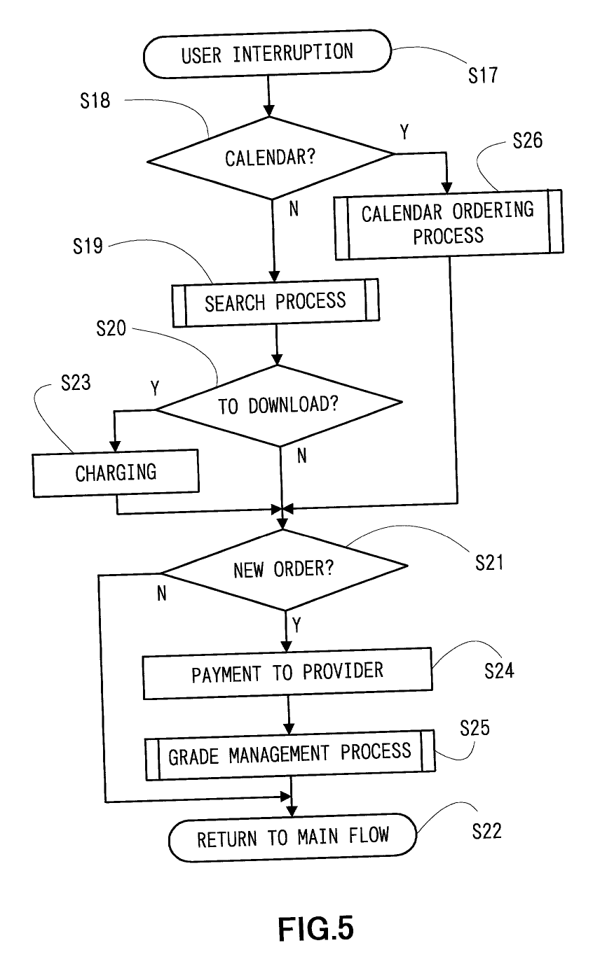

FIG. 5 represents a flow chart showing the process of utilizing the image data in image storage 1 beginning with an access form an image user, which causes the user interruption in step S17. Further in step S17, the accessing image user is identified with name, e-mail address, and telephone number, for example. If the image user is of already registered, the identification number and the password are utilized in identifying the accessing image user in step S17. The purpose of the identification of the accessing image user is not for any limitation to the image user as in the image provider, but for the convenience of the image user only.

In step S18, it is checked whether or not the image user is accessing for ordering a calendar. If the answer is “NO” in step S18, the flow goes to the search process in step S19, which makes it possible for the image user to look for a desired image data on the monitor of the personal computer 4. In step S20, it is checked whether or not the image user makes a order to download any image data. If no image data is ordered to download, the flow advances to step S22 by way of step S21 since there is no new order in this case. This means that the access by the image user results in only looking the image data stored in image storage 1, which causes the flow to return to the main flow in step S22.

On the other hand, if step S20 detects that an image data is ordered to download, the flow advances to step S23, where a bill is charged on the image user for the order. No condition is set on the usage of the ordered image data as long as the user by itself is to legally use the downloaded image data, which means that the user paying for the downloaded image data is entitled to print or copy it at anytime for any purpose. For example, the charge billed on the download of the above case is fifty thousand yen per one image data. The quality of the image data transmitted to the image user upon the paid download is extremely higher than that upon the search process in step S19. If a new order is made as in this case, step S21 leads to step S24 in which a predetermined ratio such as a 50 percent of the charge gotten from the image user is paid to the image provider of the ordered image data. The other 50 percent of the charge is kept by the system that manages image storage 1. In step S25, the grade for the limitation to the number of image data that the image provider is entitled to store is updated on the basis of the change in the achievement of the order in accordance with the above rule. The grade is upgraded if necessary in view of the rule. The upgrading means the increase of the number of the image data that the image provider is entitled to store.

If it is detected in step S18 that an image user is accessing for ordering a calendar, calendar ordering process is carried out in step S26, the detail of which is to be explained later. The achievement of the order relating to the calendar through step S26 is also counted as a new order in step S21, which leads to steps S24 and S25.

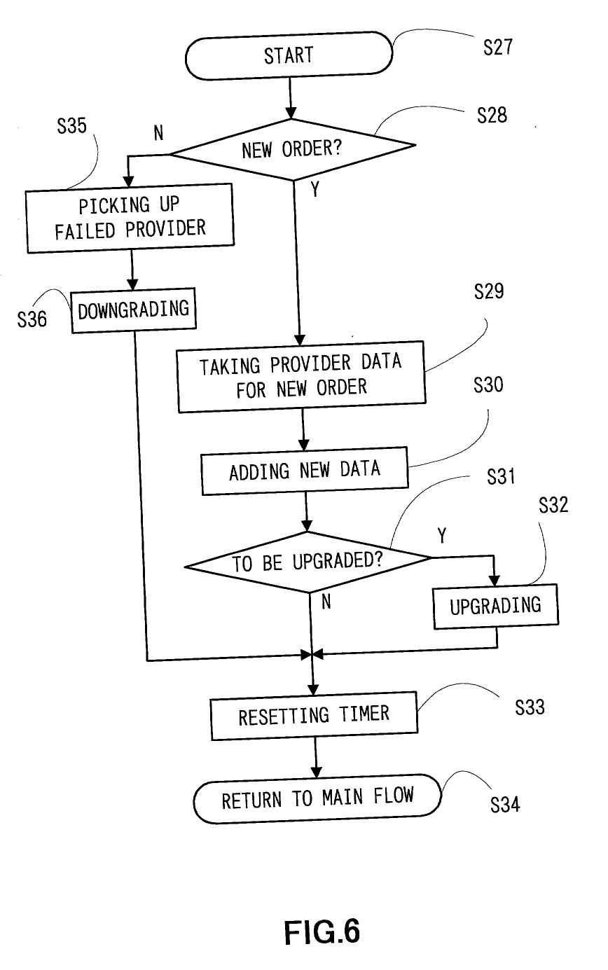

FIG. 6 represents a flow chart showing the details of the process in step S25 in FIG. 5 for updating grade for the limitation to the number of image data that an image provider is entitled to store. Beginning with step S27, it is checked in step S28 whether or not a new order is made. In the case that the flow is caused by step S21 in FIG. 21, the flow goes to step S29 for taking the order achievement data of the image provider who has gotten the new order. In step S30, the new order is added to the order achievement data to update the order record of each image data in provider data area 10 in FIG. 2. In step S31, the updated record of the image provider is checked with the rule to determine whether the image provider is to be upgraded. For example, if an image provider of the grade entitled to provide two image data has already gotten an order from one image user in the latest one month, an additional order gotten for the same image data from another image user results in an achievement of getting orders from two image users within one month, which fulfils the requirement for an image provider to be entitled to store five image data. So, such an image provider is upgraded in step S32 to change the data in provider data area 10 in FIG. 2 with respect to the grade of the image provider.

The upgrading of an image provider means a better chance for the image provider of getting orders since the selection of image users within the same image provider are widened by the increased number of its image data. In other words, the more an image provider becomes popular, the more the image provider makes business chances. In step S33, a one month timer is reset as to an image provider whose grade is changed, the one month timer relating to provider data area 10 in FIG. 2 for counting a period of one month for each image provider. The one month timer is for downgrading an image provider with insufficient achievement. The flow then returns to the main flow in step S34.

If the updated record of the image provider does not fulfil the requirement for the image provider to be upgraded, the flow directly goes to step S33 followed by step S34.

The grade management interruption referred to in relation to step S5 of FIG. 3 also starts the flow chart in FIG. 6 for updating the limitation to the number of image data that an image provider is entitled to store. As has been explained, the grade management interruption is to be automatically caused once a day. If the grade management interruption is automatically caused, the flow beginning with step S27 goes to step S35 by way of step S28 since no new order is made in this case. In step S35, all achievement of orders within the latest one month for all the image data of all the image providers are reviewed to pick image a provider who has failed to fulfill the requirement of the rule of its grade in the latest one month. The one month timer judges the failure. Each picked up image provider is downgraded in step S36 to change the data in provider data area 10 in FIG. 2 with respect to the grade of the image provider. For example, if an image provider of the grade entitled to provide one hundred image data has failed to get orders from more than one thousand image users as to all of the image data in the latest one month, the image provider is downgraded to the lower grade entitled to provide twenty image data. Thus, even an image provider once winning the honor of the top grade may be downgraded unless the image provider makes efforts to continuously create, with fully making use of the possible one hundred image data, at least one attractive image data getting orders from more than one thousand image users in every month. In step S33, the one month timer is reset as to the image provider whose grade is downloaded.

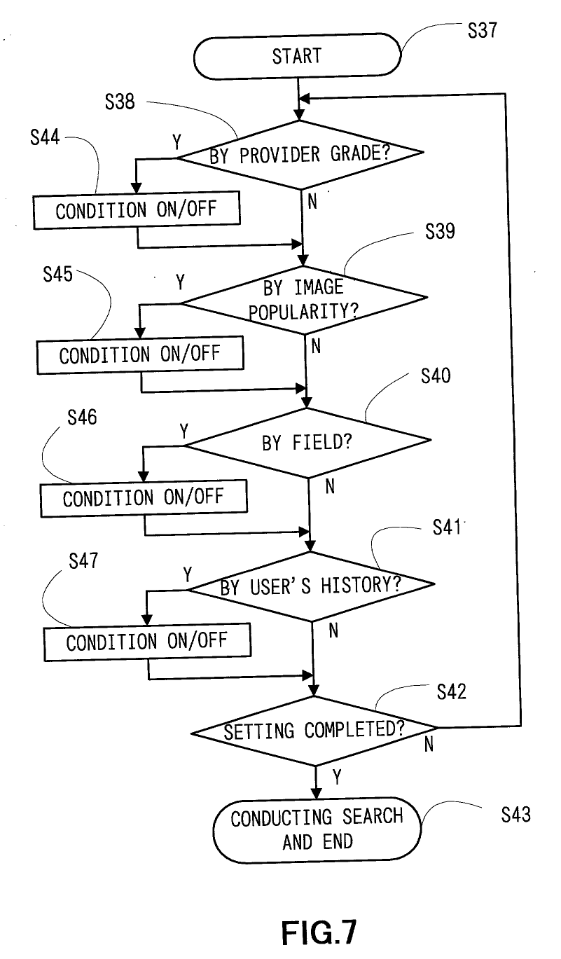

FIG. 7 represents a f low chart showing the details of the search process in step S19 of FIG. 5. Beginning with step S37, various searching conditions are to be set in steps S38 to S41. The initial status of each of the searching conditions is in “OFF” state, respectively, when the flow is to start from step S37. If the completion of the searching conditions setting is confirmed is step S42, the flow goes to step S43, in which the search under the set conditions is carried out to end the process. On the contrary, if the answer is “NO” to the question in step S42, the flow returns to step S38 for changing the search condition setting.

Step S38 makes a question whether or not to change the condition on the grade of the image provider. A search on such a condition is possible by means of data stored in provider data area 10 in FIG. 2. If the answer is “YES” in step S38, step S44 changes the initial condition, “OFF” into “ON” state. If the condition on the grade of the image provider is made “ON” with the top grade designated for example, image data created by the image providers in the top grade only are to be searched. Various designations of the grade or combinations thereof are possible according to the need of an image user. Thus, a search for image data limited only to popular image providers or only to fresh unknown image providers or any other purpose of search by the grade of the image provider may be possible.

Step 44 is of a nature to cyclically switch the condition between “ON” and “OFF” states. Therefore, if the flow goes from step S38 to step S44 with the condition on the grade previously in “ON” state, step S44 changes the condition from “ON” state to “OFF” state to thereby conduct a search free from any limitation to the grade. This nature is true also in steps S45 to S47.

Step S39 makes a question whether or not to change the condition on the popularity of individual image data regardless of the grade of the image provider. A search on such a condition is also possible by means of data stored in provider data area 10 in FIG. 2. If the condition on the popularity of image data is made “ON” designating the image data with the achievement of more than one thousand orders for example, only such the popular image data are to be searched. Various designations of the popularity or combinations thereof are possible according to the need of an image user. Thus, a search limited only to highly popular image data or only to unappreciated image data or any other purpose of search by popularity may be possible. The setting through steps s39 and S45 also makes it possible to search image data by the time passed from the provision. Thus, a search limited only to new image data provided within the latest one month for example.

Step S40 makes a question whether or not to change the condition on the field of individual image data regardless of the image provider. Also a search on such a condition is possible by means of data stored in provider data area 10 in FIG. 2. If the condition on the field of image data is made “ON” designating one of “places”, “seasons”, “sports”, “flowers”, or “landscapes” for example, only image data in the designated field are to be searched.

Step S41 makes a question whether or not to change the condition on the history of access to each image data by the accessing image user. A search on this condition is possible by means of data stored in user data area 11 in FIG. 2. If the condition on such a user access history is made “ON” designating image data that the accessing image user has never accessed, only image data new for the accessing image user are to be searched. Thus, the accessing user can efficiently search the image data with any duplicate access avoided. On the other hand, if the condition on the user access history is made “ON” designating favorite image data that the accessing image user has marked, the image user can quickly search image data among the favorite ones.

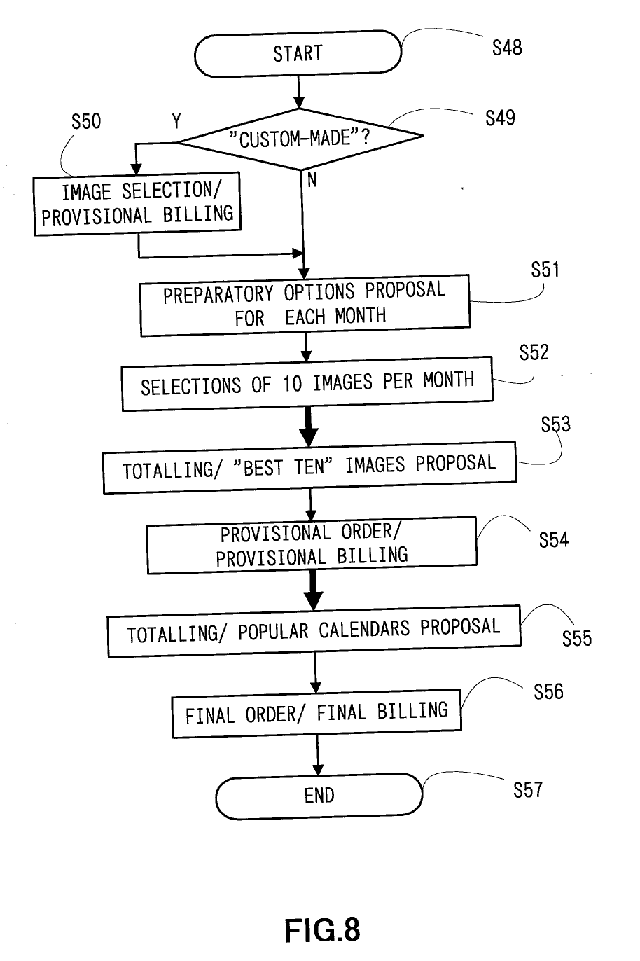

FIG. 8 represents a flowchart showing a calendar ordering process in step S26 of FIG. 5 in detail. In the calendar ordering process, an image user selects twelve image data corresponding to the twelve months of the year to have the hard copies thereof produced, which are bound into a calendar to be delivered to the image user. The calendar ordering process requires a series of accesses from the same image user to be intermittently made in a period. In consideration of this, FIG. 8 does not show details of such a flow chart that a computer carries out in response to each access, but shows an outline flow covering all the accesses in order to grasp the entire concept of the calendar ordering process. In the process, the word, “hard copy” means a tangible body that is a recording medium such as a paper or a plastic sheet, on which image information is printed by a printing machine in a mass production system or a printer such as a photographic printer or an electronic digital printer.

The flow of FIG. 8 starts with step S48. In step S49, it is determined whether a calendar type is of a “custom-made” on the basis of the order of the accessing image user. In the case of the “custom-made” calendar, the image user in step S50 selects twelve arbitrary images corresponding to twelve months of the year to send the result to image storage 1. In response to this, a provisional charge for the order is billed to the image user also in step S50, the billing data being sent to the personal computer of the image user. The charge for a calendar in the provisional billing is, for example, 2,000 yen apiece. In this stage, any actual payment is not conducted, but the provisional billing is sent only for information for the image user who keeps an option of switching the order into a “semi-custom-made” calendar. After the image user has selected images and the provisional billing has been conducted in step S50, the process continues to step S51. In step S51 and thereafter, a process for the “semi-custom-made” calendar is performed. The image user of the “custom-made” calendar can freely join the process for the “semi-custom-made” calendar.

If a calendar type is not of the “custom-made” in step S49, the order is for “semi-custom-made” calendar, which advances the flow directly to step S51. In step S51, a plurality of proposed image data for each month are transferred to an image user s computer from the image data area 9 in FIG. 2 for monitor of the image user. For example, the number of proposed image data is about one hundred for each month. In step S52, the image user selects ten image data for each month among the proposed image data of each month to sends the selection result of every month to image storage 1 in the form of voting. The vote is made with an obligation that the image user is to accept and buy any one of the own voted ten image data for each month if it is ranked in the “best ten”, which is explained later. In step S52, the image user can vote any image data stored in image data area 9 even if the image data is not proposed in step S51. If such an image becomes popular as a result of the vote though its possibility is low, the image could be selected as one of the “best ten” as a calendar image. That is all for the first access for the calendar order from the image user. During a predetermined period, an indefinite number of image users interested in the calendar order will join the first access.

When a next access from the same image user comes for the calendar ordering process, the process starts from step S17 and goes through steps S18 to S26 in FIG. 5, which causes the flow in FIG. 8 beginning with step S53 this time. The bold arrow such as between steps S52 and S53 means that there is a lapse of time between the two steps and the process stops temporarily during this period. In step S53, voting by an indefinite number of image users is closed and the result of the voting is totaled. Also in step S53, “best ten” image data for each month are transferred to image user's computer from image storage 1, and are displayed on the computer. Since each image user selects ten image data for each month in the vote, it is expected in a considerable possibility that the image user likely finds at least one image data originated from its own selection among the “best ten” image data determined as a result of the vote. Even an image data that an image user has personally ranked law in own selection of the ten image data may be popular and ranked in the “best ten” if a majority of image users have done the same in the own selections, respectively. The rank of such an image data may be higher than that of the personal best image data of each image user if the best image data of the individual image user differs from each other in the vote. Further, such a possibility is not negligible that an image user finds at least one own selection among the “best ten” from the vote as to all the twelve months. This means that a considerable number of image users can get a satisfactory full calendar from the “best ten” of all months.

In step S54, an image user who can be satisfied with the “best ten” image data of all months arbitrarily selects an image data per each month to collect a total of twelve image data and sends the selection result to image storage 1 as a provisional order. Also in step S53, a charge is provisionally billed on the provisional order through the image user's computer. The charge of the provisional billing, is 1,500 yen for example, which is cheaper than 2,000 yen on “custom-made” calendar. The reason why the charge on the “semi-custom-made” calendar is set cheaper than that on the “custom-made” calendar is that a “semi-custom-made” calendars are to be produced by a printing machine in the mass production in contrast to a “custom-made” calendars individually produced by a printer. In step S54, an image user who cannot get satisfactory image data for twelve months within the “best ten” image data may change the order into a “custom-made” calendar type in which other image data are gotten from image storage 1. That is all for the second access by the image user in the calendar ordering process. An indefinite number of image users interested in the calendar order will join the second access also during a predetermined period.

When a third access from the same image user comes for the calendar ordering process, the process starts again from step S17 and goes through steps S18 to S26 in FIG. 5, which causes the flow in FIG. 8 beginning with step S55 this time. In step S55, the provisional orders for the calendars are collected. Also in step S55, popular calendars are picked up and sent to the personal computers of all the image users along with the prices. Thus, all the image users are informed of the entire current status of the calendar ordering process, so that each image user has an opportunity to change its order. A further cheap price is set on the popular calendars that can be produced in large quantities. For example, 1,000 yen is set on the popular calendars in comparison with 1,500 yen on the ordinary “semi-custom-made” calendars. In step S56, image users finally fix the order with necessary changes made according to the information above to send the results to image storage 1, thereby the orders for the calendars and the charges thereon are to be completed followed by step S57 closing the calendar ordering process. By the way, it may be possible in step S55 to subdivide the popular calendars into a plurality of the ranks and the prices thereon. For example, the best three popular calendars may be priced at 500 yen, other popular calendar within the best ten ranks at 700 yen, and other popular calendars at 1,000 yen. These prices are determined by considering the number of orders and the cost of producing the calendars.

Summarization of the examples of charges on various cases of calendars is as follows: less than 1,000 yen for an image user who originally selects or changes to a popular calendar; 1,500 yen for an image user who insists on the provisional “semi-custom-made” calendar made in step S54 that does not lead to a popular calendar in step S55; 2,000 yen for an image user who insists on the original “custom-made” calendar; and 2,000 yen for an image user who has changed the “semi-custom-made” calendar into the “custom-made” calendar in step S54. An image user who has already determined image data for its calendar and is not interested in the later steps may omits any of the steps between steps S51 and S55, and waits the time when the calendar ordering process reaches step S56. As long as the “custom-made” calendar, an image user can fix the order anytime, regardless of the executing time of steps S51 through S55.

In the above embodiment, the voting is made as to each month in step S52 to pick up “best ten” image data for each month for selection in step S53. In this case, if each image user is allowed to arbitrarily selects one print of the image data among “best ten” image data for each month to orders a calendar, it is necessary to prepare a sufficient number of sheets of prints for each of possible 120 image data (10 options multiplied by 12 months). However, there may be a possibility that only one sheet of print is actually needed as to a certain image data in spite of the selections made by all the relating image users since their selections are arbitrary. It is necessary to determine the cost of the entire process with such a case also taken into consideration. In comparison with the above cost determination, a modification of calendar layout including two months and one image data per one page is to be considered, thereby the modification of the calendar consists of 6 pages in total for one year. It is further assumed in the modification that an image user is to select one image data among “best five” image data for each page to orders a calendar. In such a modification, it is necessary to prepare a sufficient number of sheets of prints for each of possible 30 image data (5 options multiplied by 6 pages). In this case, though a cost of preparing possible prints may decrease, the option of the image users to select image data for getting a satisfactory calendar would be limited, which would lead to a decrease of the number of orders. Thus, the calendar ordering process according to the invention must be planned with the balance between these conditions fully taken into consideration.

Also in the case of a new order for a calendar, step S21 of the flow in FIG. 5 goes to step S24 in which a predetermined ratio such as a 50 percent of the charge finally billed to the image user is paid to the image provider of the ordered image data. In step S25, the data of achievement of orders is updated and the grade for the limitation to the number of image data that the image provider is entitled to store is upgraded if necessary in view of the rule. The image provider can expect a great number of orders for the same image data through the order for producing calendar. In other words, an image provider will have a chance of winning a great deal of money and a great degree of upgrading through a calendar ordering process.

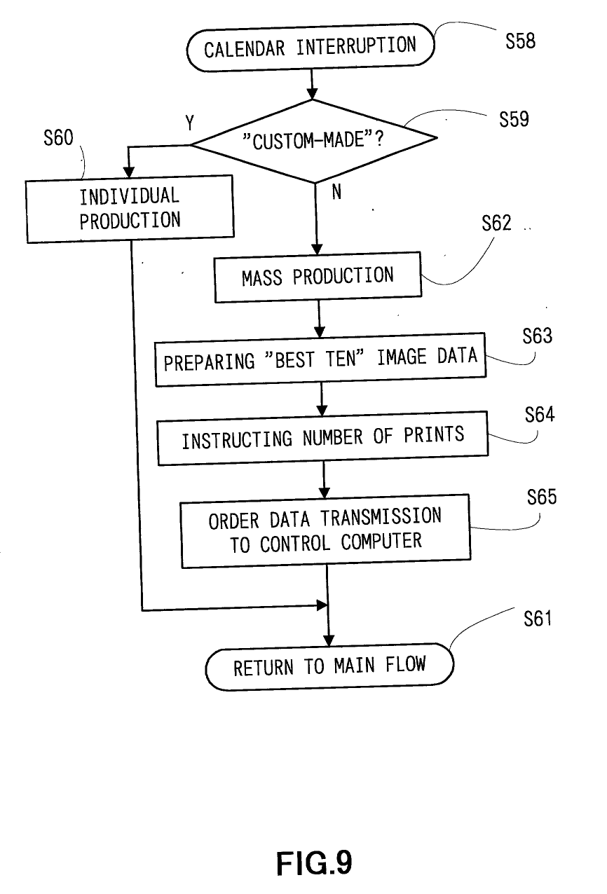

FIG. 9 represents a flowchart showing a calendar producing process beginning with step S58 in response to the calendar interruption that has been enabled in step S4 of FIG. 3. The calendar interruption is caused when a calendar production is implemented in response to the orders from image users after the calendar ordering process has been completed. When the interruption is caused, the flow goes to step S59 from step S58. In step S59, it is determined whether a calendar type is of “custom-made” If the answer is “YES”, the flow goes to step S60. In step S60, it is instructed to print hard copies by a printer individually. Subsequent to the instruction, image data is output and transferred to the printer for printing the image data on a hard copy. The printed hard copies are delivered to image users respectively. Step S60 completing the above functions is followed by step S61 for returning to the main flow.

If the calendar type is of “semi-custom-made” in step S59, the process goes to step S62. In step S62, it is instructed to print hard copies with a mass production printing machine. In step S63, image storage 1 outputs “best ten” image data for each month that are required to form various “semi-custom-made” calendar, the “best ten” image data being transmitted to the printing machine. In step S64, all orders of the “semi-custom-made” calendars are totaled to calculate the number of sheets for each of the “best ten” image data, the number being instructed to the printing machine to start the printings. In step S65, instruction according to each of the orders is transmitted to a computer that controls the image printing, the calendar production, and the delivery. In step S61, the process returns to the main flow.

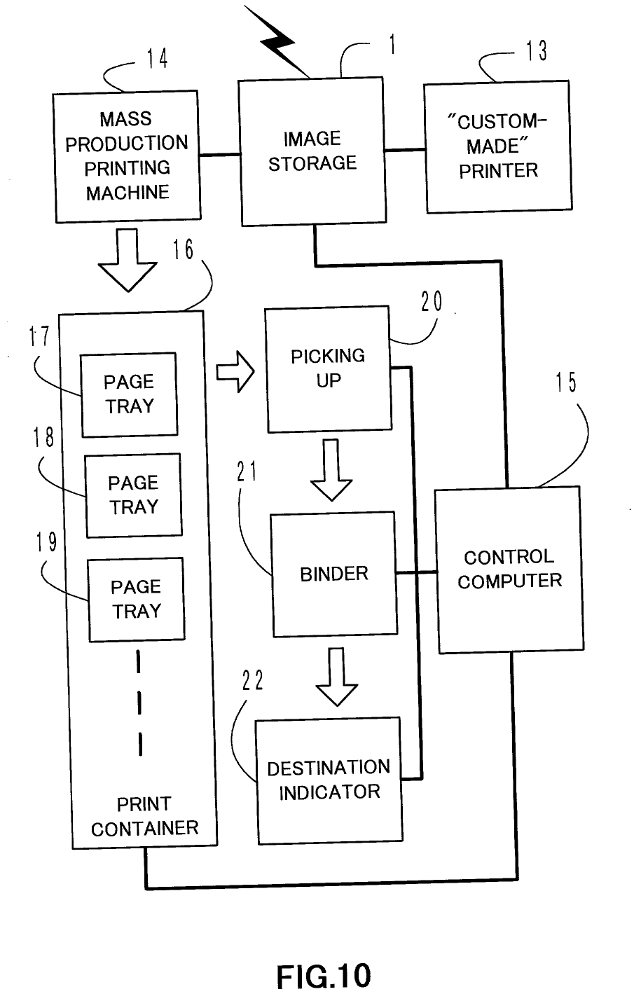

FIG. 10 represents a block diagram showing a calendar production apparatus. For a “custom-made” calendar, image storage 1 transmits image data to “custom-made” printer 13. On the other hand, image storage 1 transmits image data to mass production printing machine 4 for a “semi-custom-made” calendar. Image storage 1 transmits necessary data to control computer 15 for assigning the control of the image printing, the calendar production, and the delivery.

In the case of “semi-custom-made” type order, printing machine 14 prints the designated number of sheets of “best ten” image data from image storage 1 for each-month. The printed sheets are transferred from printing machine 14 to print container 16 including page trays 17, 18 and 19 and so on, each tray keeping printed sheets produced on one image data, respectively. For example, page tray 17 keeps a number of sheets of the first optional image data for January, page tray 18 of the second optional image data also for January, and page tray 19 of the third optional image data still also for January. Thus, print container 16 includes 120 page trays in total for individually keeping the sheets of prints of 120 image data, respectively, the last page tray keeping a number of sheets of the tenth optional image for December.

Picking up 20 picks up and stacks twelve sheets of the print of image data to form a calendar in accordance with an order from an image user under the control of control computer 15. For example, a sheet of the print of the third optional image is picked up for January, a sheet of the print of the tenth optional image is picked up for February and stacked on the sheet of January, a sheet of the print of the sixth optional image is picked up for March and stacked on the sheet of February, and so on up to December in accordance with an order from an image user. Binder 21 binds the twelve sheets of as a calendar in a proper form. Destination indicator 22 identified each image user for each calendar and indicates the individual destination of the calendars. Thus, each image user can receive its own “semi-custom-made” calendar.

The following description relates to a modification of step 55 of FIG. 8 in which the step is modified so that a more detailed and delicate option in ordering a calendar is possible. According to the original embodiment, the charge of 1,500 yen is to be billed in step S56 on an image user who insists on its own provisional order for calendar that has not become a popular calendar in step S55. Such an image user may have insisted on the provisional order even in a case where eleven month of image data are the same as image data of a popular calendar and only one image data for the remaining one month differs. On the other hand, as previously described, it could happen that only one sheet of print is actually needed for one image data among the 120 types of image data on which the printing machine has prepared the sheets of prints. Provided that the one image data is common to both the above two cases, the image user can get a popular calendar with the cost of 1,000 yen and the preparation by the printing machine for the one image data can be omitted to save the production cost if the image user knows the fact and accepts to replace the one month of image data with the image data of the popular calendar. This change of order is advantageous to both the image user and the calendar producer.

Similar situation is also true as to an image user who prefers the “order-made” calendar because of only one favorite image data missing to be ranked in the “best ten” in spite of other favorite image data in the “best ten”. If the image user accepts to replace the one month of image data with an image data among “best ten” image data, it is possible for the image user to get a “semi-order-made” calendar produced by a printing machine on the basis of the “best ten” image data, which reduces the charge on the image user from 2,000 yen to 1,500 yen.

In order to realize such a detailed and delicate change in the order, the following modification of embodiment is provided. Namely, the image users are to be informed in step S55 of FIG. 8 of the individual popularity of each image data as well as the popular calendars. The image users are to be further informed of the cost of producing calendar with all the popular image data throughout the twelve month, the cost of which would be minimum due to the high efficiency of mass production. Those information would prompt the image users to replace the image data in the ordered calendars for seeking a lower cost. The information of the cost may be prepared with respect to a plurality of models in advance, or calculated day by day on the basis of the actual change in the orders by the image users. This is possible to modify step S56 of FIG. 8 so that an image user can replace an ordered image data for each page and send the change to image storage 1. It is theoretically possible to calculate the cost information in real time by totaling the order data or the change therein. The image users are informed of the change in calculated cost in real time.

What is claimed is:

1. An image storage comprising:
a memory that stores a plurality of digital image data provided by a plurality of image providers;
a recorder that records the history of use by a plurality of image users with respect to each of the digital image data; and
a controller that controls a condition for each image provider in storing the digital image in accordance with the recorder.

2. The image storage according to claim 1, wherein the condition for each image provider is the number of the digital image data that the image provider is entitled to store in the memory.

3. The image storage according to claim 1, wherein the recorder is designed to record the number of orders from the image users for each of the digital image data.

4. The image storage according to claim 3, wherein the controller is designed to control the condition for each image provider in accordance with the number of orders in a predetermined period for the digital image data stored by the image provider.

5. The image storage according to claim 4, wherein the condition for each image provider is the number of the digital image data that the creator is entitled to store in the memory.

6. The image storage according to claim 5, wherein the controller is designed to increase the number of the digital image data for the image provider if the number of the order for the digital image data of the image provider increases.

7. The image storage according to claim 5, wherein the controller is designed to decrease the number of the digital image data for the image provider if the number of the order for the digital image data of the image provider decreases.

8. The image storage according to claim 1, further comprising a searcher that searches the memory for digital image data fulfilling a given condition set on the history recorded by the recorder.

9. The image storage according to claim 8, wherein the given condition is set on the number of orders from the image users for each of the digital image data recorded by the recorder.

10. The image storage according to claim 9, wherein the given condition is that the number of orders for the digital image data is greater than a given number, whereby a popular digital image data fulfils the condition.

11. The image storage according to claim 9, wherein the given condition is that the number of orders for the digital image data is less than a given number, whereby an unappreciated digital image data fulfils the condition.

12. The image storage according to claim 8, wherein the given condition is set on the image provider with the condition in storing the digital image.

13. The image storage according to claim 12, wherein the given condition is that the number of the digital image data that the image provider is entitled to store in the memory is greater than a given number, whereby a digital image data provided by a popular image provider fulfils the condition.

14. The image storage according to claim 12, wherein the given condition is that the number of the digital image data that the image provider is entitled to store in the memory is less than a given number, whereby a digital image data provided by a fresh image provider fulfils the condition.

15. The image storage according to claim 1 further comprising printed matter production system that makes use of the digital image data in the memory for a production of printed matter.

16. The image storage according to claim 15, wherein the printed matter production system includes an acceptor that accepts from an image user a designation of a set of digital image data for an order of printed matter.

17. The image storage according to claim 16, wherein the printed matter production system further includes a selector that selects a type of printer suitable for individual production of the printed matter.

18. The image storage according to claim 15, wherein the printed matter production system includes a proposer that proposes a plurality of optional digital image data for selection by a plurality of potential image users for calendar, an acceptor that accepts the selections by the potential image users, and a decider that decides to realize a mass production of printed matter in accordance with the accepted selections.

19. The image storage according to claim 18, wherein the printed matter production system further includes a selector that selects a type of printer suitable for mass production of the printed matter

20. The image storage according to claim 1 further comprising a selector that selects one of a plurality of types of printers for producing a print of a digital image data in accordance with an order from an image user.

21. The image storage according to claim 20, wherein the selector is designed to select the printer between a first type of printer suitable for individual production of the print of a digital image data and a second type of printer suitable for mass production of the print of the digital image data in accordance with the number of orders for producing prints of the digital image data from the image users.

22. A method of facilitating the circulation of digital image data stored in a memory comprising the steps of:
storing digital image data of a plurality of image providers in the memory;
informing a plurality of image users of the digital image data;
accepting orders from an image user for a digital image data;
recording the history of the order for each digital image data; and
controlling a condition for each image provider in storing the digital image in accordance with the history of the order for the digital image data of the image provider.

23. The method according to claim 22, wherein the condition for each image provider is the number of the digital image data that the image provider is entitled to store in accordance with the number of orders accepted in a predetermined period for the digital image data of the image provider.

24. An image storage comprising:
a memory that stores a plurality of digital provided by a plurality of image providers;
a recorder that records the history of use by a plurality of image users with respect to each of the digital image data; and
a searcher that searches the memory for a digital image data fulfilling a given condition set on the history recorded by the recorder.

25. The image storage according to claim 24, wherein the given condition is set on the number of orders from the image users for each of the digital image data recorded by the recorder.

26. The image storage according to claim 25, wherein the given condition is set on a relationship between the number of orders for the digital image data and a given number, whereby a digital image data is searched for depending on the popularity of the digital image data.

27. The image storage according to claim 24, wherein the given condition is set on the image provider with the condition in storing the digital image.

28. The image storage according to claim 27, wherein the given condition is set on a relationship between the number of digital image data that the image provider is entitled to store in the memory and a given number, whereby a digital image data is searched for depending on the popularity of the image provider who stores the image.

29. An image storage comprising:
a memory that stores a plurality of digital image data provided by a plurality of image providers;
a recorder that records the history of use by a plurality of image users with respect to each of the digital image data; and
a selector that selects one of a plurality of types of printers for producing a print of a digital image data in accordance with an order from an image user.

30. The image storage according to claim 29, wherein the selector is designed to select the printer between a first type of printer suitable for individual production of the print of a digital image data and a second type of printer suitable for mass production of the print of the digital image data in accordance with the number of orders for producing prints of the digital image data from the image users.

31. A method of producing printed matter from a plurality of digital image data stored in a memory comprising the steps of:
storing a plurality of digital image data in the memory;
proposing a plurality of optional digital image data for selection by a plurality of potential image users for printed matter;
accepting the selections by the potential image users; and
deciding on a mass production of printed matter in accordance with the accepted selections.

32. The method according to claim 31, further comprising a step of informing the potential image users of preparatory proposals of the digital image data and a step of hearing responses thereto from the potential image users, the proposing step being conducted in accordance with the responses.

33. The method according to claim 31, wherein a plurality of groups of digital image data are proposed in the proposing step, and wherein selections of one digital image data from every group are accepted in the accepting step.

34. A method of producing printed matter from a plurality of digital image data stored in a memory comprising the steps of:
storing a plurality of digital image data in the memory;
proposing a plurality of groups of optional digital image data for selection by a plurality of image users for printed matter;
accepting the selections of one digital image data from every group by each image user; and
producing printed matter for each image user in accordance with the selections, respectively.

35. A method of producing printed matter from a plurality of digital image data stored in a memory comprising the steps of:
storing a plurality of digital image data in the memory;
proposing a plurality of groups of optional digital image data for selection by a plurality of image users for printed matter;
accepting the selections of one digital image data from every group by each image user;
informing each image user of the total result of the selections by the image users; and
allowing each image user to change the selection in view of the informed total result.

36. A printed matter producing system comprising:
a container including a plurality of groups of sub-containers each keeping a plurality of sheets of print produced on one image source,-respectively;
a selector that selects one sheet from a sub-container of every group, respectively, the option of the sub-container among every group being depending on an order by an image user for printed matter ; and
a binder that binds the selected sheets into printed matter

37. A method of producing a product from a plurality of elements comprising the steps of:
proposing a plurality of optional elements for selection by a plurality of potential users;
accepting the selections by the potential users; and
deciding on a mass production of the product in accordance with the accepted selections.

38. The method according to claim 37, wherein a plurality of groups of elements are proposed in the proposing step, and wherein selections of one element from every group are accepted in the accepting step.

39. A method of producing a product from a plurality of elements comprising the steps of:
proposing a plurality of groups of optional elements for selection by a plurality of users;
accepting the selections of one element from every group by each user; and
producing a product for each user in accordance with the selections, respectively.

40. A method of producing a product from a plurality of elements comprising the steps of:
proposing a plurality of groups of optional elements for selection by a plurality of users;
accepting the selections of one element from every group by each user;
informing each user of the total result of the selections by the users; and
allowing each user to change the selection in view of the informed total result.

41. A data storage comprising:
a memory that stores a plurality of digital data provided by a plurality of providers;
a recorder that records the history of use by a plurality of users with respect to each of the digital data; and
a controller that controls a condition for each provider in storing the digital data in accordance with the recorder.
